(19) United States
(12) Patent Application Publication
(10) Pub. No.: US 2021/0350559 A1
(43) Pub. Date: Nov. 11, 2021

(54) IMAGE DEPTH ESTIMATION METHOD AND APPARATUS, ELECTRONIC DEVICE, AND STORAGE MEDIUM

(71) Applicant: Zhejiang SenseTime Technology Development Co., Ltd., Hangzhou (CN)

(72) Inventors: Yong QI, Hangzhou (CN); Xiaojun XIANG, Hangzhou (CN); Hanqing JIANG, Hangzhou (CN); Guofeng ZHANG, Hangzhou (CN)

(21) Appl. No.: 17/382,819

(22) Filed: Jul. 22, 2021

Related U.S. Application Data
(63) Continuation of application No. PCT/CN2019/101778, filed on Aug. 21, 2019.

(30) Foreign Application Priority Data
Jul. 10, 2019 (CN) 201910621318.4

(51) Int. Cl. G06T 7/55; G06T 3/40

(52) U.S. Cl. CPC G06T 7/55; G06T 2207/20016; G06T 2207/20021; G06T 3/4007

(57) ABSTRACT

An image depth estimation method, including: obtaining a reference frame corresponding to a current frame and an inverse depth space range of the current frame; performing pyramid downsampling processing on the current frame and the reference frame respectively to obtain k layers of current images corresponding to the current frame and k layers of reference images corresponding to the reference frame, where k is a natural number greater than or equal to 2; and performing inverse depth estimation iteration processing on the k layers of current images based on the k layers of reference images and the inverse depth space range to obtain inverse depth estimation results of the current frame.

### CROSS-REFERENCE TO RELATED APPLICATION

This is a continuation application of International Patent Application No. PCT/CN2019/101778, filed on Aug. 21, 2019, which claims priority to Chinese Patent Application No. 201910621318.4, filed on Jul. 10, 2019 and entitled “IMAGE DEPTH ESTIMATION METHOD AND APPARATUS, ELECTRONIC DEVICE, AND STORAGE MEDIUM”. The contents of International Patent Application No. PCT/CN2019/101778 and Chinese Patent Application No. 201910621318.4 are incorporated herein by reference in their entireties.

### BACKGROUND

Depth estimation of images is an important issue in the field of computer vision. If it is impossible to directly obtain depth information of images, three-dimensional reconstruction of scenes can only be completed by depth estimation methods, so as to serve for applications such as augmented reality applications and game applications.

At present, computer vision-based depth estimation methods can be classified into active vision methods and passive vision methods. The active vision methods refer to methods for emitting a controllable light beam to an object to be measured, then capturing an image formed by the light beam on the surface of the object, and computing a distance of the object to be measured by a geometric relationship. The passive vision methods include stereovision methods, focusing methods, defocusing methods, etc., and are mainly to determine depth information using two-dimensional image information obtained by one or more photographing devices.

### SUMMARY

The present disclosure relates to the technical field of computer vision, and in particular, to an image depth estimation method and apparatus, an electronic device, and a storage medium.

Embodiments of the present disclosure expect to provide an image depth estimation method and apparatus, an electronic device, and a storage medium.

The technical solutions in the embodiments of the present disclosure are achieved as below.

The embodiments of the present disclosure provide an image depth estimation method, including:

obtaining a reference frame corresponding to a current frame and an inverse depth space range of the current frame;

performing pyramid downsampling processing on the current frame and the reference frame respectively to obtain k layers of current images corresponding to the current frame and k layers of reference images corresponding to the reference frame, where k is a natural number greater than or equal to 2; and

performing inverse depth estimation iteration processing on the k layers of current images based on the k layers of reference images and the inverse depth space range to obtain inverse depth estimation results of the current frame.

The embodiments of the present disclosure provide an image depth estimation apparatus, including:

an obtaining section, configured to obtain a reference frame corresponding to a current frame and an inverse depth space range of the current frame;

a downsampling section, configured to perform pyramid downsampling processing on the current frame and the reference frame respectively to obtain k layers of current images corresponding to the current frame and k layers of reference images corresponding to the reference frame, where k is a natural number greater than or equal to 2; and

an estimating section, configured to perform inverse depth estimation iteration processing on the k layers of current images based on the k layers of reference images and the inverse depth space range to obtain inverse depth estimation results of the current frame.

The embodiments of the present disclosure provide an electronic device, including: a processor, a memory, and a communication bus, where

the communication bus is configured to implement connection communication between the processor and the memory; and

the processor is configured to execute an image depth estimation program stored in the memory to implement the foregoing image depth estimation method.

The embodiments of the present disclosure provide a computer-readable storage medium, where the computer-readable storage medium stores one or more programs, and the one or more programs may be executed by one or more processors so as to implement the foregoing image depth estimation method.

The embodiments of the present disclosure provide a computer program including computer-readable codes, where when the computer-readable codes are executed by a processor, the operations corresponding to the foregoing image depth estimation method are implemented.

### BRIEF DESCRIPTION OF DRAWINGS

FIG. 1 is a schematic flowchart of an image depth estimation method provided by embodiments of the present disclosure.

FIG. 2 is a schematic diagram of an exemplary included angle between camera poses provided by embodiments of the present disclosure.

FIG. 3 is schematic flowchart I of inverse depth estimation iteration processing provided by embodiments of the present disclosure.

FIG. 4 is a schematic diagram of exemplary three layers of current images provided by embodiments of the present disclosure.

FIG. 5 is a schematic flowchart of determining inverse depth candidate values provided by embodiments of the present disclosure.

FIG. 6 is a schematic diagram of exemplary sampling point projection provided by embodiments of the present disclosure.

FIG. 7 is schematic flowchart II of inverse depth estimation iteration processing provided by embodiments of the present disclosure.

FIG. 8 is a schematic structural diagram of an image depth estimation apparatus provided by embodiments of the present disclosure.

FIG. 9 is a schematic structural diagram of an electronic device provided by embodiments of the present disclosure.

### DETAILED DESCRIPTION

A first aspect of the embodiments of the present disclosure provides an image depth estimation method, including:

obtaining a reference frame corresponding to a current frame and an inverse depth space range of the current frame;

performing pyramid downsampling processing on the current frame and the reference frame respectively to obtain k layers of current images corresponding to the current frame and k layers of reference images corresponding to the reference frame, where k is a natural number greater than or equal to 2; and

performing inverse depth estimation iteration processing on the k layers of current images based on the k layers of reference images and the inverse depth space range to obtain inverse depth estimation results of the current frame.

It can be understood that in the embodiments of the present disclosure, downsampling processing is performed on the current frame and the reference frame corresponding to the current frame, and inverse depth estimation iteration processing is performed on the obtained plurality layers of current images in combination with the plurality layers of reference images to determine the inverse depth estimation results of the current frame. Since an inverse depth search space is reduced layer by layer during a process of determining the inverse depth estimation results, the computation load of inverse depth estimation is reduced and an estimation speed is improved. Therefore, the inverse depth estimation results can be obtained in real time.

In the foregoing image depth estimation method, obtaining the reference frame corresponding to the current frame includes:

obtaining at least two frames to be screened; and

selecting at least one frame from the at least two frames to be screened and taking the at least one frame as the reference frame, where the at least one frame and the current frame meet a preset angle constraint condition.

It can be understood that in the embodiments of the present disclosure, a frame having good quality and suitable for matching with the current frame can be selected to a certain extent by selecting the reference frame from at least two frames to be screened according to a preset angle constraint condition, thereby improving estimation accuracy in a subsequent depth estimation process.

In the foregoing image depth estimation method, the preset angle constraint condition includes that:

an included angle formed by a connection line between a pose center corresponding to the current frame and a target point and a connection line between a pose center corresponding to the reference frame and the target point falls within a first preset angle range, where the target point is a midpoint of a connection line between an average depth point corresponding to the current frame and an average depth point corresponding to the reference frame;

an included angle between an optical axis corresponding to the current frame and an optical axis corresponding to the reference frame falls within a second preset angle range; and

an included angle between a vertical axis corresponding to the current frame and a vertical axis corresponding to the reference frame falls within a third preset angle range.

It can be understood that in the embodiments of the present disclosure, the first angle condition defines the distances from the current scene to two cameras. If the angle is excessively large, it indicates that the scene is too close, and the degree of overlapping of two frames would be relatively low. If the angle is excessively small, it indicates that the scene is too far, the parallax is relatively small, and the error would be relatively large. If the cameras are extremely close to each other, the case where the angle is excessively small may also occur. In this case, the error is also relatively large. The second angle condition is to ensure that the two cameras have an adequate common view area. The third angle condition is to prevent the influence of the rotation of the cameras around the optical axes on a subsequent depth estimation computation process. Taking the frame simultaneously meeting the three angle conditions above as the reference frame facilities improving the precision of the depth estimation of the current frame.

In the foregoing image depth estimation method, performing inverse depth estimation iteration processing on the k layers of current images based on the k layers of reference images and the inverse depth space range to obtain inverse depth estimation results of the current frame includes:

determining inverse depth candidate values corresponding to each sampling point in ith-layer sampling points based on the k layers of current images and the inverse depth space range, where the ith-layer sampling points are pixel points obtained by performing sampling on the ith-layer current image in the k layers of current images, and i is a natural number greater than or equal to 1 and less than or equal to k;

determining inverse depth values of each sampling point in the ith-layer sampling points according to the inverse depth candidate values corresponding to each sampling point in the ith-layer sampling points and the ith-layer reference image in the k layers of reference images to obtain ith-layer inverse depth values;

letting i be equal to i+1 and continuing performing inverse depth estimation on the (i+1)th-layer current image, in the k layers of current images, having a resolution greater than that of the ith-layer current image until i=k to obtain kth-layer inverse depth values; and

determining the kth-layer inverse depth values as the inverse depth estimation results.

It can be understood that in the embodiments of the present disclosure, inverse depth estimation iteration processing is performed on the kth-layer current image based on the kth-layer reference image and the inverse depth space range. For example, inverse depth estimation iteration is sequentially performed on a lower layer, starting from the top-layer (first-layer) current image (the image having the minimum number of pixels), and an inverse depth search space is reduced layer by layer to effectively reduce the computation load of inverse depth estimation.

In the foregoing image depth estimation method, determining inverse depth candidate values corresponding to each sampling point in ith-layer sampling points based on the k layers of current images and the inverse depth space range includes:

performing interval division on the inverse depth space range and selecting an inverse depth value from each divided interval to obtain a plurality of initial inverse depth values;

determining the plurality of initial inverse depth values as inverse depth candidate values corresponding to each sampling point in first-layer sampling points;

if i is not equal to 1, obtaining (i−1)th-layer sampling points from the k layers of current images and (i−1)th-layer inverse depth values; and

determining, based on the (i−1)th-layer inverse depth values, the (i−1)th-layer sampling points, and the plurality of initial inverse depth values, the inverse depth candidate values corresponding to each sampling point in the ith-layer sampling points.

It can be understood that in the embodiments of the present disclosure, interval division is performed on the inverse depth space range to select inverse depth values from different intervals, such that each interval has one inverse depth values as the inverse depth candidate value. That is to say, each sampling point has an inverse depth candidate value in a different inverse depth range interval. In the subsequent determination of the inverse depth values of the sampling point, it can be ensured that the inverse depth values in the different inverse depth range intervals can all be used for performing inverse depth value estimation and determination, so as to ensure that the estimation process covers the whole inverse depth space range, thereby finally estimating an accurate inverse depth value.

In the foregoing image depth estimation method, determining, based on the (i−1)th layer inverse depth values, the (i−1)th-layer sampling points, and the plurality of initial inverse depth values, inverse depth candidate values corresponding to each sampling point in the ith-layer sampling points includes:

determining, from the (i−1)th-layer sampling points, a second sampling point closest to a first sampling point and at least two third sampling points adjacent to the second sampling point, where the first sampling point is any sampling point in the ith-layer sampling points;

obtaining the inverse depth value of each sampling point in the at least two third sampling points and the inverse depth value of the second sampling point according to the (i−1)th-layer inverse depth values to obtain at least three inverse depth values;

determining the maximum inverse depth value and the minimum inverse depth value from the at least three inverse depth values;

selecting, from the plurality of initial inverse depth values, inverse depth values falling within a range between the maximum inverse depth value and the minimum inverse depth value, selecting the plurality of equal-division inverse depth values, and determining the selected inverse depth values as the inverse depth candidate values corresponding to the first sampling point; and

continuing determining inverse depth candidate values corresponding to the sampling points, other than the first sampling point, in the ith-layer sampling points until the inverse depth candidate values corresponding to each sampling point in the ith-layer sampling points are determined.

It can be understood that in the embodiments of the present disclosure, determining the inverse depth candidate values of the ith-layer sampling points from the plurality of initial inverse depth values using the inverse depth values corresponding to the (i−1)th-layer sampling points can more accurately obtain the inverse depth candidate values of the ith-layer sampling points. Moreover, the number of the inverse depth candidate values is reduced. Correspondingly, the computation load of inverse depth estimation is reduced.

In the foregoing image depth estimation method, determining inverse depth values of each sampling point in the ith-layer sampling points according to the inverse depth candidate values corresponding to each sampling point in the ith-layer sampling points and the ith-layer reference image in the k layers of reference images to obtain ith-layer inverse depth values includes:

for each sampling point in the ith-layer sampling points, projecting each sampling point in the ith-layer sampling points to the ith-layer reference image respectively according to each inverse depth value in the corresponding inverse depth candidate values to obtain ith-layer projection points corresponding to each sampling point in the ith-layer sampling points;

performing block matching according to the ith-layer sampling points and the ith-layer projection points to obtain ith-layer matching results corresponding to each sampling point in the ith-layer sampling points; and

determining, according to the ith-layer matching results, the inverse depth values of each sampling point in the ith-layer sampling points to obtain the ith-layer inverse depth values.

It can be understood that in the embodiments of the present disclosure, the ith-layer sampling points are respectively matched with the corresponding ith-layer projection points, so as to determine the degrees of differences among projection points projected using different inverse depth values. Therefore, the inverse depth values of the ith-layer sampling points can be accurately selected.

In the foregoing image depth estimation method, performing block matching according to the ith-layer sampling points and the ith-layer projection points to obtain the ith-layer matching results corresponding to each sampling point in the ith-layer sampling points includes:

by using a preset window, selecting, from the ith-layer current image, a first image block with a sampling point to be matched as a center, and selecting, from the ith-layer reference image, a plurality of second image blocks respectively with each projection point in the ith-layer projection points corresponding to the sampling point to be matched as a center, where the sampling to be matched is any sampling point in the ith-layer sampling points;

respectively comparing the first image block with each image block in the plurality of second image blocks to obtain a plurality of matching results, and determining the plurality of matching results as ith-layer matching results corresponding to the sampling point to be matched; and

continuing determining the ith-layer matching results corresponding to the sampling points, in the ith-layer sampling points, different from the sampling point to be matched, until the ith-layer matching results corresponding to each sampling point in the ith-layer sampling points are obtained.

It can be understood that in the embodiments of the present disclosure, the matching results obtained by performing matching on the sampling points and the projection points using block matching are actually matching penalty values which represent the degrees of differences between the projection points and the sampling points and correspondingly also represent the degrees that the inverse depth values for the projection of the projection points can be taken as the inverse depth values of the sampling points. Therefore, the inverse depth values of the sampling points can be subsequently accurately selected using the results.

In the foregoing image depth estimation method, determining, according to the ith-layer matching results, the inverse depth values of each sampling point in the ith-layer sampling points to obtain the ith-layer inverse depth values includes:

selecting a target matching result from ith-layer matching results corresponding to a target sampling point, where the target sampling point is any sampling point in the ith-layer sampling points;

determining the projection point, in the ith-layer projection points corresponding to the target sampling point, corresponding to the target matching result as a target projection point;

determining inverse depth values, in the inverse depth candidate values, corresponding to the target projection point as inverse depth values of the target sampling point; and

continuing determining the inverse depth values of the sampling points, in the ith-layer sampling points, different from the target sampling point until the inverse depth values of each sampling point in the ith-layer sampling points are determined to obtain the ith-layer inverse depth values.

It can be understood that in the embodiments of the present disclosure, the foregoing process for sampling point matching is actually respectively determining, for a sampling point, the degrees of differences among projection points projected using different inverse depth values. A result having the minimum matching result value, which represents the minimum degree of difference between the corresponding projection point and the sampling point, is selected. Therefore, the inverse depth value used by the projection point can be determined as the inverse depth value of the sampling point, so as to obtain an accurate inverse depth value of the sampling point.

In the foregoing image depth estimation method, after obtaining the kth-layer inverse depth values, the method further includes:

performing interpolation optimization on the kth-layer inverse depth values to obtain optimized kth-layer inverse depth values; and

determining the optimized kth-layer inverse depth values as the inverse depth estimation results.

It can be understood that in the embodiments of the present disclosure, the depths estimated in the foregoing process are discrete values. Therefore, secondary interpolation may further be performed to adjust the inverse depths of each sampling point, so as to obtain more accurate inverse depth values.

In the foregoing image depth estimation method, performing interpolation optimization on the kth-layer inverse depth values to obtain optimized kth-layer inverse depth values includes:

for each inverse depth value in the kth-layer inverse depth values, respectively selecting adjacent inverse depth values from candidate inverse depth values of a corresponding sampling point in the kth-layer sampling points, where the kth-layer sampling points are pixel points obtained by performing sampling on the kth-layer current image in the k layers of current images;

obtaining matching results corresponding to the adjacent inverse depth values; and

performing interpolation optimization on each inverse depth value in the kth-layer inverse depth values based on the adjacent inverse depth values and the matching results corresponding to the adjacent inverse depth values to obtain the optimized kth-layer inverse depth values.

It can be understood that in the embodiments of the present disclosure, interpolation adjustment can be more accurately performed on the inverse depth values of a sampling pint using the determined inverse depth values of the sampling point, the adjacent inverse depth values thereof, and the matching results corresponding to the adjacent inverse depth values, and the adjustment mode is simple and rapid.

A second aspect of the embodiments of the present disclosure provides an image depth estimation apparatus, including:

an obtaining section, configured to obtain a reference frame corresponding to a current frame and an inverse depth space range of the current frame;

a downsampling section, configured to perform pyramid downsampling processing on the current frame and the reference frame respectively to obtain k layers of current images corresponding to the current frame and k layers of reference images corresponding to the reference frame, where k is a natural number greater than or equal to 2; and

an estimating section, configured to perform inverse depth estimation iteration processing on the k layers of current images based on the k layers of reference images and the inverse depth space range to obtain inverse depth estimation results of the current frame.

In the foregoing image depth estimation apparatus, the obtaining section is specifically configured to: obtain at least two frames to be screened; and select at least one frame from the at least two frames to be screened and take the at least one frame as the reference frame, where the at least one frame and the current frame meet a preset angle constraint condition.

In the foregoing image depth estimation apparatus, the preset angle constraint condition includes that:

an included angle formed by a connection line between a pose center corresponding to the current frame and a target point and a connection line between a pose center corresponding to the reference frame and the target point falls within a first preset angle range, where the target point is a midpoint of a connection line between an average depth point corresponding to the current frame and an average depth point corresponding to the reference frame;

an included angle between an optical axis corresponding to the current frame and an optical axis corresponding to the reference frame falls within a second preset angle range; and

an included angle between a vertical axis corresponding to the current frame and a vertical axis corresponding to the reference frame falls within a third preset angle range.

In the foregoing image depth estimation apparatus, the estimating section is specifically configured to: determine inverse depth candidate values corresponding to each sampling point in ith-layer sampling points based on the k layers of current images and the inverse depth space range, where the ith-layer sampling points are pixel points obtained by performing sampling on the ith-layer current image in the k layers of current images, and i is a natural number greater than or equal to 1 and less than or equal to k; determine inverse depth values of each sampling point in the ith-layer sampling points according to the inverse depth candidate values corresponding to each sampling point in the ith-layer sampling points and the ith-layer reference image in the k layers of reference images to obtain ith-layer inverse depth values; let i to be equal to i+1 and continue performing inverse depth estimation on the (i+1)th-layer current image, in the k layers of current images, having a resolution greater than that of the ith-layer current image until i=k to obtain kth-layer inverse depth values; and determine the kth-layer inverse depth values as the inverse depth estimation results.

In the foregoing image depth estimation apparatus, the estimating section is specifically configured to: perform interval division on the inverse depth space range and select an inverse depth value from each divided interval to obtain a plurality of initial inverse depth values; determine the plurality of initial inverse depth values as inverse depth candidate values corresponding to each sampling point in the first-layer sampling points; if i is not equal to 1, obtain (i−1)th-layer sampling points from the k layers of current images and (i−1)th-layer inverse depth values; and determine, based on the (i−1)th layer inverse depth values, the (i−1)th-layer sampling points, and the plurality of initial inverse depth values, the inverse depth candidate values corresponding to each sampling point in the ith-layer sampling points.

In the foregoing image depth estimation apparatus, the estimating section is specifically configured to: determine a second sampling point closest to a first sampling point and at least two third sampling points adjacent to the second sampling point from the (i−1)th-layer sampling points, where the first sampling point is any sampling point in the ith-layer sampling points; obtain the inverse depth value of each sampling point in the at least two third sampling points and the inverse depth value of the second sampling point according to the (i−1)th-layer inverse depth values to obtain at least three inverse depth values; determine the maximum inverse depth value and the minimum inverse depth value from the at least three inverse depth values; select, from the plurality of initial inverse depth values, inverse depth values falling within a range between the maximum inverse depth value and the minimum inverse depth value, and determine the selected inverse depth values as inverse depth candidate values corresponding to the first sampling point; and continue determining inverse depth candidate values corresponding to the sampling points, other than the first sampling point, in the ith-layer sampling points until the inverse depth candidate values corresponding to each sampling point in the ith-layer sampling points are determined.

In the foregoing image depth estimation apparatus, the estimating section is specifically configured to: for each sampling point in the ith-layer sampling points, project each sampling point in the ith-layer sampling points to the ith-layer reference image respectively according to each inverse depth value in the corresponding inverse depth candidate values to obtain ith-layer projection points corresponding to each sampling point in the ith-layer sampling points; perform block matching according to the ith-layer sampling points and the ith-layer projection points to obtain ith-layer matching results corresponding to each sampling point in the ith-layer sampling points; and determine, according to the ith-layer matching results, the inverse depth values of each sampling point in the ith-layer sampling points to obtain the ith-layer inverse depth values.

In the foregoing image depth estimation apparatus, the estimating section is specifically configured to: by using a preset window, select, from the ith-layer current image, a first image block with a sampling point to be matched as a center, and select, from the ith-layer reference image, a plurality of second image blocks respectively with each projection point in the ith-layer projection points corresponding to the sampling point to be matched as a center, where the sampling to be matched is any sampling point in the ith-layer sampling points; respectively compare the first image block with each image block in the plurality of second image blocks to obtain a plurality of matching results, and determine the plurality of matching results as ith-layer matching results corresponding to the sampling point to be matched; and continue determining the ith-layer matching results corresponding to the sampling points, in the ith-layer sampling points, different from the sampling point to be matched, until the ith-layer matching results corresponding to each sampling point in the ith-layer sampling points are obtained.

In the foregoing image depth estimation apparatus, the estimating section is specifically configured to: select a target matching result from ith-layer matching results corresponding to a target sampling point, where the target sampling point is any sampling point in the ith-layer sampling points; determining the projection point, in the ith-layer projection points corresponding to the target sampling point, corresponding to the target matching result as a target projection point; determine inverse depth values, in the inverse depth candidate values, corresponding to the target projection point as inverse depth values of the target sampling point; and continue determining the inverse depth values of the sampling points, in the ith-layer sampling points, different from the target sampling point until the inverse depth values of each sampling point in the ith-layer sampling points are determined to obtain the ith-layer inverse depth values.

In the foregoing image depth estimation apparatus, the estimating section is further configured to: perform interpolation optimization on the kth-layer inverse depth values to obtain optimized kth-layer inverse depth values; and determine the optimized kth-layer inverse depth values as the inverse depth estimation results.

In the foregoing image depth estimation apparatus, the estimating section is specifically configured to: for each inverse depth value in the kth-layer inverse depth values, respectively select adjacent inverse depth values from candidate inverse depth values of a corresponding sampling point in the kth-layer sampling points, where the kth-layer sampling points are pixel points obtained by performing sampling on the kth-layer current image in the k layers of current images; obtain matching results corresponding to the adjacent inverse depth values; and perform interpolation optimization on each inverse depth value in the kth-layer inverse depth values based on the adjacent inverse depth values and the matching results corresponding to the adjacent inverse depth values to obtain the optimized kth-layer inverse depth values.

A third aspect of the embodiments of the present disclosure provides an electronic device, including: a processor, a memory, and a communication bus, where

the communication bus is configured to implement connection communication between the processor and the memory; and

the processor is configured to execute an image depth estimation program stored in the memory to implement the foregoing image depth estimation method.

In the foregoing electronic device, the electronic device is a mobile phone or a tablet computer.

A fourth aspect of the embodiments of the present disclosure provides a computer-readable storage medium, where the computer-readable storage medium stores one or more programs, and the one or more programs may be executed by one or more processors so as to implement the foregoing image depth estimation method.

A fifth aspect of the embodiments of the present disclosure provides a computer program including computer-readable codes, where when the computer-readable codes are executed by a processor, the operations corresponding to the foregoing image depth estimation method are implemented.

Therefore, in the technical solutions of the embodiments of the present disclosure, a reference frame corresponding to a current frame and an inverse depth space range of the current frame are obtained; pyramid downsampling processing is performed on the current frame and the reference frame respectively to obtain k layers of current images corresponding to the current frame and k layers of reference images corresponding to the reference frame, where k is a natural number greater than or equal to 2; and inverse depth estimation iteration processing is performed on the k layers of current images based on the k layers of reference images and the inverse depth space range to obtain inverse depth estimation results of the current frame. That is to say, the technical solutions provided by the present disclosure perform inverse depth estimation iteration processing on a plurality of layers of current images in combination with a plurality of layers of reference images to reduce the inverse depth search space layer by layer to determine the inverse depth estimation results of the current frame. The inverse depth estimation results are reciprocals of z axis coordinate values of pixel points of the current frame in a camera coordinate system, and do not require additional coordinate transformation. Moreover, reducing the inverse depth search space layer by layer facilitates reducing the computation load of inverse depth estimation and improving an estimation speed. Therefore, a depth estimation result of an image can be obtained in real time and the depth estimation result has high accuracy.

The technical solutions in embodiments of the present disclosure are clearly and completely described below with reference to the accompanying drawings in the embodiments of the present disclosure.

The embodiments of the present disclosure provide an image depth estimation method. The execution subject of the image depth estimation method is an image depth estimation apparatus. For example, the image depth estimation method can be executed by a terminal device or a server or other electronic devices, where the terminal devices may be a User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the image depth estimation method may be implemented by invoking, by a processor, computer readable instructions stored in a memory. FIG. 1 is a schematic flowchart of an image depth estimation method provided by the embodiments of the present disclosure. As shown in FIG. 1, the following operations are mainly included.

At S101, a reference frame corresponding to a current frame and an inverse depth space range of the current frame are obtained.

In the embodiments of the present disclosure, description is made by taking the execution object being an image depth estimation apparatus as an example. First, when performing depth estimation on a current frame, the image depth estimation apparatus needs to first obtain a reference frame corresponding to the current frame and an inverse depth space range of the current frame.

It should be noted that in the embodiments of the present disclosure, the current frame is an image on which depth estimation needs to be performed while the reference frame is an image for performing reference matching when depth estimation is performed on the current frame. There may be a plurality of reference frames. In consideration of the balance between the speed and robustness of depth estimation, it is appropriate to select about five reference frames. The specific reference frame of the current frame is not limited in the embodiments of the present disclosure. Specifically, in the embodiments of the present disclosure, obtaining, by the image depth estimation apparatus, the reference frame corresponding to the current frame includes the following operations: obtaining at least two frames to be screened, and selecting at least one frame from the at least two frames to be screened and taking the at least one frame as the reference frame, where the at least one frame and the current frame meet a preset angle constraint condition.

It should be noted that in the embodiments of the present disclosure, the image depth estimation apparatus can also obtain the reference frame in other modes, for example, receiving a selection instruction for at least two frames to be screened sent from a user and taking at least one frame indicated by the selection instruction as the reference frame. The specific reference frame obtaining mode is not limited in the embodiments of the present application.

It should be noted that in the embodiments of the present disclosure, a plurality of reference frames corresponding to the current frame may be selected from the at least two frames to be screened by the image depth estimation apparatus, and each reference frame and the current frame meet a preset angle constraint condition. The frames to be screened are images obtained for the same scene as but at different angles from the current frame. The image depth estimation apparatus may be configured with a photographing module, and the frames to be screened may be obtained by the photographing module. Certainly, the frames to be screened may also be first obtained by other independent photographing devices, and the image depth estimation apparatus then further obtains the frames to be screened from the photographing devices. The specific preset angle constraint condition may be preset in the image depth estimation apparatus according to actual depth estimation requirements, may also be stored in other apparatuses and obtained from the other apparatuses when depth estimation needs to be performed, or may also be obtained by receiving an angle constraint condition input by the user, which is not limited in the embodiments of the present disclosure.

Specifically, in the embodiments of the present disclosure, the preset angle constraint condition includes that: an included angle formed by a connection line between a pose center corresponding to the current frame and a target point and a connection line between a pose center corresponding to the reference frame and the target point falls within a first preset angle range, where the target point is a midpoint of a connection line between an average depth point corresponding to the current frame and an average depth point corresponding to the reference frame; an included angle between an optical axis corresponding to the current frame and an optical axis corresponding to the reference frame falls within a second preset angle range; and an included angle between a vertical axis corresponding to the current frame and a vertical axis corresponding to the reference frame falls within a third preset angle range. The vertical axis is Y-axis of a camera coordinate system in a three-dimensional space.

In some embodiments of the present disclosure, the pose center corresponding to the current frame is actually a center (an optical center) of a camera when the camera is at the position and attitude for obtaining the current frame. The pose center corresponding to the reference frame is actually a center (an optical center) of the camera when the camera is at the position and attitude for obtaining the reference frame.

Exemplarily, in the embodiments of the present disclosure, as shown in FIG. 2, it is defined that: the pose of the camera when obtaining the current frame is pose 1, and the pose of the camera when obtaining the reference frame is pose 2; at pose 1, the average depth point between the center (the optical center) of the camera and a corresponding scene is point P1, and at pose 2, the average depth point between the center (the optical center) of the camera and the corresponding scene is point P2; and the midpoint of the connection line between P1 and P2 is point P. The preset angle constraint condition specifically includes three angle conditions: the first angle condition is that an angle of view α formed by the connection line between the center of the camera at pose 1 and the point P and the connection line between the center of the camera at pose 2 and the point P falls within the range of [5°, 45°]; the second angle condition is that an included angle between optical axes of the camera at pose 1 and pose 2 falls within the range of [0°, 45°]; and the third angle condition is that an included angle between Y-axes of the camera at pose 1 and pose 2 falls within the range of [0°, 30°]. Only a frame simultaneously meeting the three angle conditions can be taken as a reference frame. The angle intervals above can all be adjusted in practice.

It should be noted that in the embodiments of the present disclosure, the camera for obtaining the current frame and the reference frame may be configured with a positioning apparatus to directly obtain corresponding poses when obtaining the current frame and the reference frame. The image depth estimation apparatus may obtain the related poses obtained in the positioning apparatus. Certainly, the image depth estimation apparatus may also compute the corresponding poses with reference to some feature points in the obtained current frame and reference frame according to a pose estimation algorithm.

It can be understood that in the embodiments of the present disclosure, the first angle condition defines the distances from the current scene to two cameras. If the angle is excessively large, it indicates that the scene is too close, and the degree of overlapping of two frames would be relatively low. If the angle is excessively small, it indicates that the scene is too far, the parallax is relatively small, and the error would be relatively large. If the cameras are extremely close to each other, the case where the angle is excessively small may also occur. In this case, the error is also relatively large. The second angle condition is to ensure that the two cameras have an adequate common view area. The third angle condition is to prevent the influence of the rotation of the cameras around the optical axes on a subsequent depth estimation computation process. Taking the frame simultaneously meeting the three angle conditions above as the reference frame facilities improving the precision of the depth estimation of the current frame.

It should be noted that in the embodiments of the present disclosure, the image depth estimation apparatus may directly obtain a corresponding inverse depth space range according to the current frame, where the inverse depth space range is the space range of inverse depth values of pixel points in the current frame. Certainly, the image depth estimation apparatus may also receive a setting instruction of the user and obtain an inverse depth space range instructed by the user according to the setting instruction. The specific inverse depth space range is not limited in the embodiments of the present disclosure. For example, if the inverse depth space range is [dmin, dmax], dmin is the minimum inverse depth value in the inverse depth space range and dmax is the maximum inverse depth value in the inverse depth space range.

At S102, pyramid downsampling processing is performed on the current frame and the reference frame, respectively to obtain k layers of current images corresponding to the current frame and k layers of reference images corresponding to the reference frame, where k is a natural number greater than or equal to 2.

In the embodiments of the present disclosure, after obtaining the reference frame corresponding to the current frame, the image depth estimation apparatus can perform pyramid downsampling processing on the current frame and the reference frame, respectively to obtain k layers of current images corresponding to the current frame and k layers of reference images corresponding to the reference frame.

It should be noted that in the embodiments of the present disclosure, since there may be a plurality of reference frames, the image depth estimation apparatus performs pyramid downsampling processing on each reference frame image, respectively. Therefore, a plurality of groups of k layers of reference images is actually obtained. The specific number of k layers of reference images is not limited in the embodiments of the present disclosure.

It should be noted that in the embodiments of the present disclosure, a current image pyramid and a reference image pyramid obtained by performing pyramid downsampling processing on the current frame and the reference frame respectively by the image depth estimation apparatus have the same number of layers and also use the same scale factor. For example, the image depth estimation apparatus performs downsampling having a scale factor of 2 on the current frame and the reference frame respectively to form three layers of current images and three layers of reference images. In the two groups of three layers of images, the top-layer images have the lowest resolutions, the middle-layer images have resolutions greater than those of the top-layer images, and the bottom-layer images have the highest resolutions. Actually, the bottom-layer images are original images, i.e., the corresponding current frame and reference frame. The specific number of image layers k and the scale factor of downsampling can be preset according to actual requirements, which are not limited in the embodiments of the present disclosure.

Exemplarily, in the embodiments of the present disclosure, the image depth estimation apparatus obtains five reference frames corresponding to current frame It, which are respectively reference frame I1, reference frame I2, reference frame I3, reference frame I4, and reference frame I5. The image depth estimation apparatus performs downsampling having a scale factor of 2 on these frames respectively to obtain three layers of current images corresponding to the current frame It and three layers of reference images respectively corresponding to the reference frame I1, the reference frame I2, the reference frame I3, the reference frame I4, and the reference frame I5.

At S103, inverse depth estimation iteration processing is performed on the k layers of current images based on the k layers of reference images and the inverse depth space range to obtain inverse depth estimation results corresponding to the current frame.

In the embodiments of the present disclosure, after obtaining the k layers of current images and the k layers of reference images, the image depth estimation apparatus can perform inverse depth estimation iteration processing on the k layers of current images based on the k layers of reference images and the inverse space range, for example, starting from the top-layer (first-layer) current image (the image having the minimum number of pixels), sequentially performing inverse depth estimation iteration on a lower layer, and reducing an inverse depth search space layer by layer till the bottommost k^{th} layer to obtain inverse depth estimation results corresponding to the current frame.

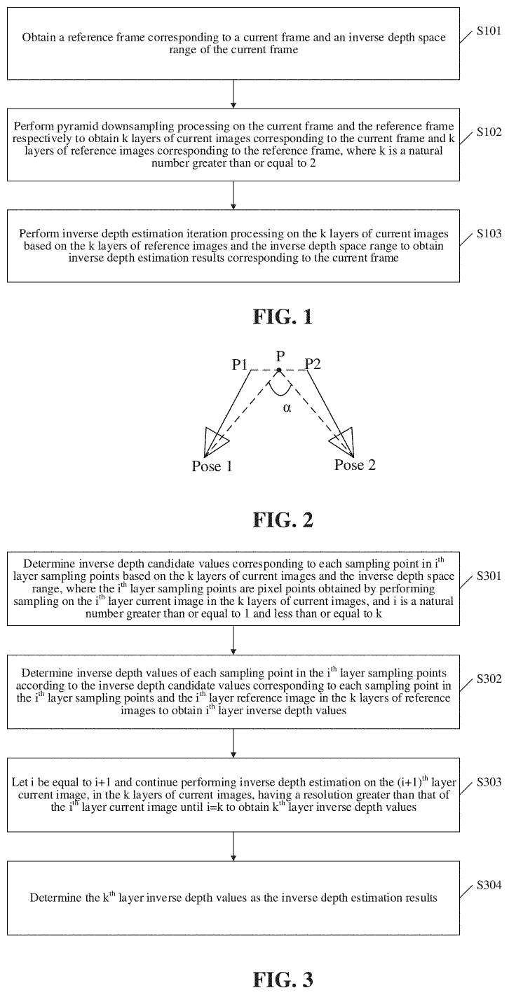

FIG. 3 is schematic flowchart I of inverse depth estimation iteration processing provided by the embodiments of the present disclosure. As shown in FIG. 3, performing, by the image depth estimation apparatus, inverse depth estimation iteration processing on the k layers of current images based on the k layers of reference images and the inverse depth space range to obtain the inverse depth estimation results corresponding to the current frame includes the following operations.

At S301, inverse depth candidate values corresponding to each sampling point in i^{th}-layer sampling points are determined based on the k layers of current images and the inverse depth space range, where the i^{th}-layer sampling points are pixel points obtained by performing sampling on the i^{th}-layer current image in the k layers of current images, and i is a natural number greater than or equal to 1 and less than or equal to k.

In the embodiments of the present disclosure, the k layers of current images includes, according to the order of ascending resolutions, a first-layer current image, a second-layer current image, a third-layer current image, . . . , and a k^{th}-layer current image, where the first-layer current image is the top-layer image in the k layers of current images and the k^{th}-layer current image is the bottom-layer image in the current image pyramid. Similarly, the k layers of reference images includes, according to the order of ascending resolutions, a first-layer reference image, a second-layer reference image, a third-layer reference image, . . . , and a k^{th}-layer reference image, where the first-layer reference image is the top-layer image in the reference image pyramid and the k^{th}-layer reference image is the bottom-layer image in the reference image pyramid.

It should be noted that in the embodiments of the present disclosure, the image depth estimation apparatus can perform pixel point sampling on the i^{th}-layer current image in the k layers of current images. The sampled pixel points are the i^{th}-layer sampling points. The specific value of i is a natural number greater than 1 and less than or equal to k, which is not limited in the embodiments of the present disclosure.

It should be noted that in the embodiments of the present disclosure, performing pixel point sampling on the i^{th}-layer current image by the image depth estimation apparatus can be implemented according to a preset sampling operation size. The specific sampling operation length can be determined according to actual requirements, which is not limited in the embodiments of the present disclosure.

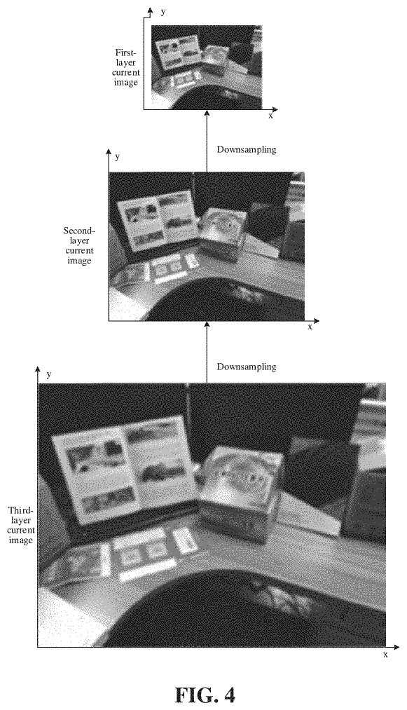

FIG. 4 is a schematic diagram of exemplary three layers of current images provided by the embodiments of the present disclosure. As shown in FIG. 4, the image depth estimation apparatus can perform, for the current frame, pixel point sampling on x-axis and y-axis coordinates according to a sampling operation size of 2 in advance to obtain three layers of current images in total, where the first-layer current image has the lowest resolution, the second-layer current image has a resolution greater than that of the first-layer current image, and the third-layer current image has a resolution greater than that of the second-layer current image, where the third-layer current image is actually the original image of the current frame.

Specifically, in the embodiments of the present disclosure, determining, based on the k layers of current images and the inverse depth space range by the image depth estimation apparatus, i^{th}-layer inverse depth candidate values corresponding to each sampling point in the i^{th}-layer sampling points includes: when i is equal to 1, performing equal interval division on the inverse depth space range to obtain a plurality of equal-division inverse depth values for interval division, and determining the plurality of equal-division inverse depth values as inverse depth candidate values corresponding to each sampling point in first-layer sampling points; when i is not equal to 1, obtaining (i−1)^{th}-layer sampling points and (i−1)^{th} layer inverse depth values from the k layers of current images, and determining, based on the (i−1)^{th} layer inverse depth values, the (i−1)^{th}-layer sampling points, and the plurality of equal-division inverse depth values, the inverse depth candidate values corresponding to each sampling point in the i^{th}-layer sampling points.

It can be understood that in the embodiments of the present disclosure, the image depth estimation apparatus performs interval division on the inverse depth space range to select inverse depth values from different intervals, such that each interval has an inverse depth value as the inverse depth candidate value. That is to say, each sampling point has an inverse depth candidate value in a different inverse depth range interval. In the subsequent determination of the inverse depth values of the sampling point, it can be ensured that the inverse depth values in the different inverse depth range intervals can all be used for performing inverse depth value estimation and determination, so as to ensure that the estimation process covers the whole inverse depth space range, thereby finally estimating accurate inverse depth values.

It can be understood that in the embodiments of the present disclosure, if i is equal to 1, the image depth estimation apparatus needs to determine inverse depth candidate values corresponding to each sampling layer in the first-layer sampling points, where the first-layer sampling points are the sampling points in the first-layer current image having the lowest resolution in the k layers of current images. The image depth estimation apparatus obtains the inverse depth space range [dmin, dmax] corresponding to the current frame, can equally divide same to obtain q equal-division inverse depth values d1, d2, . . . , and dq for interval division, and can determine all the q equal-division inverse depth values as initial inverse depth values, i.e., the inverse depth candidate values corresponding to each sampling point in the first-layer sampling points. Certainly, the inverse depth candidate values may also include dmin and dmax. That is, the inverse depth candidate values corresponding to each sampling point in the first-layer sampling points are identical. The image depth estimation apparatus can set the equal-division intervals of the inverse depth space range according to actual requirements, which is not limited in the embodiments of the present disclosure. It should be noted that in the embodiments of the present disclosure, if the image depth estimation apparatus performs interval division on the inverse depth space range according to the foregoing equal division mode and takes the inverse depth values for interval division as inverse depth candidate values, it can be ensured that the inverse depth candidate values evenly cover the whole inverse depth space range and that the inverse depth values subsequently determined from the inverse depth candidate values are more accurate.

It should be noted that in the embodiments of the present disclosure, if i is equal to 1, in addition to the equal division mode, the inverse depth space range may also be divided in a non-equal division mode. For example, the inverse depth space range is divided sequentially according to a plurality of preset different spacings, or spacing adjustment is performed after every division based on a preset initial division spacing and a spacing change rule, and then next interval division is performed using the adjusted spacing. Certainly, the selection of the initial inverse depth value may be directly and randomly selecting an inverse depth value from a divided interval, and may also be selecting the middle inverse depth value of each divided interval. The specific interval division mode and initial inverse depth value selection mode are not limited in the embodiments of the present disclosure.

It should be noted that in the embodiments of the present disclosure, if i is not equal to 1, the image depth estimation apparatus needs to obtain (i−1)^{th}-layer sampling points from the k layers of current images, i.e., the pixel points obtained by performing sampling on the (i−1)^{th}-layer sampling points in the k layers of current images, and further needs to obtain (i−1)^{th}-layer inverse depth values. The current image of each layer can be sampled with a different sampling operation size. Before determining the inverse depth candidate values corresponding to each sampling in the i^{th}-layer sampling points, if i=i−1, the image depth estimation apparatus has obtained the i^{th}-layer inverse depth values according to the foregoing inverse depth estimation operation, i.e., the inverse depth values of each sampling point in the (i−1)^{th}-layer sampling points. Therefore, the image depth estimation apparatus can directly obtain the (i−1)^{th}-layer inverse depth values, and further determine, according to the (i−1)^{th}-layer inverse depth values, the (i−1)^{th}-layer sampling points, and the plurality of equal-division inverse depth values, the inverse depth candidate values corresponding to each sampling point in the i^{th}-layer sampling points.

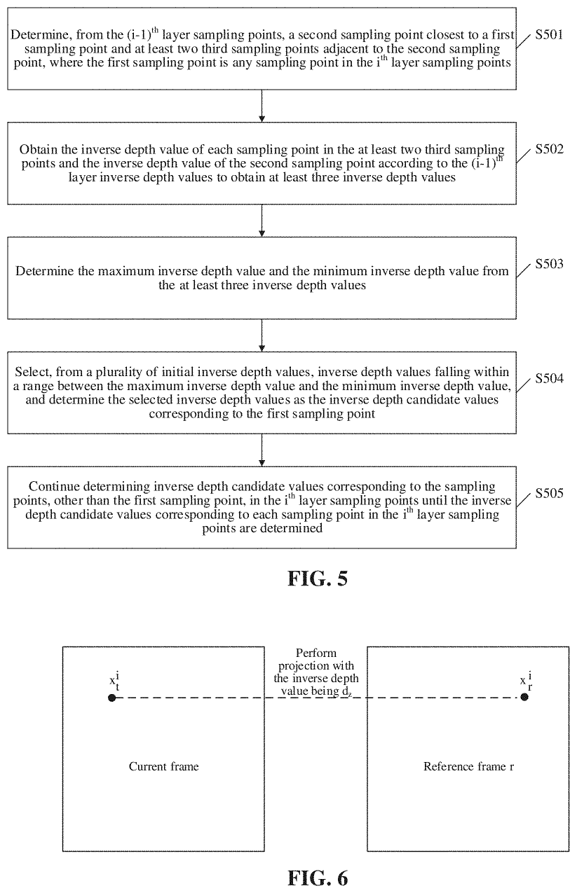

FIG. 5 is a schematic flowchart of determining inverse depth candidate values provided by the embodiments of the present disclosure. As shown in FIG. 5, determining, by the image depth estimation apparatus based on the (i−1)^{th} layer inverse depth values, the (i−1)^{th}-layer sampling points, and the plurality of initial inverse depth values, the inverse depth candidate values corresponding to each sampling point in the it-layer sampling points includes the following operations.

At S501, a second sampling point closest to a first sampling point and at least two third sampling points adjacent to the second sampling point are determined from the (i−1)^{th}-layer sampling points, where the first sampling point is any sampling point in the i^{th}-layer sampling points.

At S502, inverse depth values of each sampling point in the at least two third sampling points and an inverse depth value of the second sampling point are obtained according to the (i−1)^{th}-layer inverse depth values to obtain at least three inverse depth values.

At S503, the maximum inverse depth value and the minimum inverse depth value are determined from the at least three inverse depth values.

At S504, inverse depth values falling within a range between the maximum inverse depth value and the minimum inverse depth value are selected from the plurality of initial inverse depth values, and the selected inverse depth values are determined as the inverse depth candidate values corresponding to the first sampling point.

At S505, inverse depth candidate values corresponding to the sampling points, other than the first sampling point, in the i^{th}-layer sampling points are continued being determined until the inverse depth candidate values corresponding to each sampling point in the i^{th}-layer sampling points are determined.

It should be noted that in the embodiments of the present disclosure, if i is equal to 1, the inverse depth candidate values corresponding to each sampling point in the i^{th}-layer sampling points, i.e., the first-layer sampling points, are identical. However, if i is not equal to 1, the i^{th}-layer inverse depth candidate values corresponding to each sampling point in the i^{th}-layer sampling points can be selected from the plurality of initial inverse depth values according to the (i−1)^{th}-layer sampling points and the (i−1)^{th}-layer inverse depth values to determine the inverse depth candidate values within a relatively small range, and the inverse depth candidate values corresponding to each sampling point in the i^{th}-layer sampling points may be different.

Exemplarily, in the embodiments of the present disclosure, x [symbol] is any sampling point in the i^{th}-layer sampling points. The image depth estimation apparatus can search the (i−1)^{th}-layer sampling points for a sampling point x [symbol] closest to x [symbol] , so as to determine, with x [symbol] as a center, a plurality of (for example, eight) sampling points adjacent to the x [symbol] from the (i−1)^{th}-layer sampling points. Then, inverse depth values of x [symbol] and each sampling point in the eight sampling points adjacent to x [symbol] , i.e., nine inverse depth values, are obtained according to the (i−1)^{th}-layer inverse depth values. Furthermore, with the maximum inverse depth value d1 and the minimum inverse depth value d2 in the nine inverse depth values as boundaries, depth values, in the plurality of initial inverse depth values, between d1 and d2, including d1 and d2, are selected and determined as candidate inverse depth values corresponding to x [symbol] .

It should be noted that in the embodiments of the present disclosure, the image depth estimation apparatus determines, from the (i−1)^{th}-layer sampling points, the third sampling point adjacent to the second sampling point, and may determine eight sampling points around the second sampling point as the third sampling points. Certainly, the image depth estimation apparatus may also determine the two sampling points adjacent to the left and right sides of the second sampling point or the two sampling points adjacent to the up and down sides of the second sampling point as the third sampling points, or may further determine the four sampling points adjacent to the up, down, left and right sides of the second sampling point as the third sampling points. The specific number of the third sampling points is not limited in the embodiments of the present disclosure.

It should be noted that in the embodiments of the present disclosure, the image depth estimation apparatus can further determine, according to other rules, the inverse depth candidate values corresponding to each sampling point in the i^{th}-layer sampling points. For example, different inverse depth candidate values set by the user for sampling points of different layers are received, and the inverse depth candidate values corresponding to each sampling point in sampling points of the same layer are the same. The specific mode of determining the inverse depth candidate values is not limited in the embodiments of the present disclosure.

At S302, inverse depth values corresponding to each sampling point in the i^{th}-layer sampling points are determined according to the inverse depth candidate values corresponding to each sampling point in the i^{th}-layer sampling points and the i^{th}-layer reference image in the k layers of reference images to obtain i^{th}-layer inverse depth values.

Specifically, in the embodiments of the present disclosure, determining, by the image depth estimation apparatus, inverse depth values corresponding to each sampling point in the i^{th}-layer sampling points according to the inverse depth candidate values corresponding to each sampling point in the i^{th}-layer sampling points and the i^{th}-layer reference image in the k layers of reference images to obtain i^{th}-layer inverse depth values includes: for each sampling point in the i^{th}-layer sampling points, projecting each sampling point in the i^{th}-layer sampling points to the i^{th}-layer reference image respectively according to each inverse depth value in the corresponding inverse depth candidate values to obtain i^{th}-layer projection points corresponding to each sampling point in the i^{th}-layer sampling points; performing block matching according to the i^{th}-layer sampling points and the i^{th}-layer projection points to obtain i^{th}-layer matching results corresponding to each sampling point in the i^{th}-layer sampling points; and determining, according to the i^{th}-layer matching results, the inverse depth values of each sampling point in the i^{th}-layer sampling points to obtain the i^{th}-layer inverse depth values.

It should be noted that in the embodiments of the present disclosure, the image depth estimation apparatus projects each sampling point in the i^{th}-layer sampling points to the i^{th}-layer reference image according to each inverse depth value in the corresponding inverse depth candidate values. Certainly, if there is a plurality of reference frames, there is correspondingly a plurality of i^{th}-layer reference images. Then, the image depth estimation apparatus respectively projects each sampling point in the i^{th}-layer sampling points to each k^{th}-layer reference image according to each inverse depth value in the corresponding inverse depth candidate values.

Specifically, in the embodiments of the present disclosure, for the current frame t and the reference frame r, the image depth estimation apparatus projects any sampling point Xₜⁱ=[u, v] in the i^{th}-layer sampling points to the k^{th}-layer reference image according to any inverse depth value d [symbol] in the inverse depth candidate values corresponding to x [symbol] and the following formula (1) and formula (2), where u and v are the x-axis and y-axis coordinates of the sampling point:

$$\begin{matrix}{X}_{r} = {KR}_{r} ( {d}_{z}^{- 1} {K}^{- 1} [ {x}_{t}^{i} , 1 ] ) + {KT}_{v} , \\ K = [ \begin{matrix}{f}_{x}^{i} & 0 & {c}_{x}^{i} \\ 0 & {f}_{y}^{i} & {c}_{y}^{i} \\ 0 & 0 & 1\end{matrix} ] & ( 1 ) \\ {x}_{r}^{i} = [ {X}_{r} ( 0 ) / {X}_{r} ( 2 ) , {X}_{r} ( 1 ) / {X}_{r} ( 2 ) ] & ( 2 )\end{matrix}$$

It should be noted that K is a camera intrinsic parameter matrix corresponding to the camera for obtaining the current frame t and the reference frame r, fₓⁱ and f_{y}ⁱ are scale factors, measured on the x axis and the y axis based on pixels, of a focal length corresponding to the i^{th}-layer current image, fₓⁱ is the length of an x-axis direction focal length described by pixels, and f_{y}ⁱ is the length of a y-axis direction focal length described by pixels. (cₓⁱ, c_{y}ⁱ) is the main point position of the i^{th}-layer current image, R [symbol] is a 3×3 rotation matrix, and Tᵣ is a 3×1 translation vector. Xᵣ finally obtained according to formula (1) is a 3×1 matrix, where a first row element is Xᵣ(0), a second row element is Xᵣ(1), and a third row element is Xᵣ(2). By performing further computation according to formula (2), a projection point Xᵣⁱ projected by the sampling point Xₜⁱ to the i^{th}-layer reference image in the reference frame r according to the inverse depth value d_{z} in the corresponding inverse depth candidate values can be obtained.

It can be understood that in the embodiments of the present disclosure, each sampling point in the i^{th}-layer sampling points can be projected to the i^{th}-layer reference image by the formula (2) and the formula (3) according to each inverse depth value in the corresponding inverse depth candidate values. If there is a plurality of i^{th}-layer reference images, the execution is repeated.

It should be noted that in the embodiments of the present disclosure, after obtaining the i^{th}-layer projection points, the image depth estimation apparatus can perform block matching according to the i^{th}-layer sampling points and the i^{th}-layer projection points. Specifically, the image depth estimation apparatus performs block matching on each sampling point in the i^{th}-layer sampling points and each projection point in the corresponding i^{th}-layer projection points to obtain i^{th}-layer matching results corresponding to each sampling point.

Specifically, in the embodiment of the present disclosure, performing, by the image depth estimation apparatus, block matching according to the i^{th}-layer sampling points and the i^{th}-layer projection points to obtain the i^{th}-layer matching results corresponding to each sampling point in the i^{th}-layer sampling points includes: by using a preset window, selecting, from the i^{th}-layer current image, a first image block with a sampling point to be matched as a center, and selecting, from the i^{th}-layer reference image, a plurality of second image blocks respectively with each projection point in the i^{th}-layer projection points corresponding to the sampling point to be matched as a center, where the sampling to be matched is any sampling point in the i^{th}-layer sampling points; respectively comparing the first image block with each image block in the plurality of second image blocks to obtain a plurality of matching results, and determining the plurality of matching results as i^{th}-layer matching results corresponding to the sampling point to be matched; and continuing determining i^{th}-layer matching results corresponding to the sampling points, in the i^{th}-layer sampling points, different from the sampling point to be matched, until the i^{th}-layer matching results corresponding to each sampling point in the i^{th}-layer sampling points are obtained. For example, in the i^{th}-layer current image and the i^{th}-layer reference image, field points of the sampling points and the projection points are obtained, using a 3×3 window, respectively with each sampling point of the i^{th}-layer sampling points and the projection point corresponding thereto as centers to obtain two image blocks, and then pixel values of pixel points at corresponding positions in the obtained image blocks are compared to obtain values of punishment matching the two image blocks (for example, the sum of absolute values of pixel differences). For a same inverse depth value, a penalty value can be obtained in each i^{th}-layer reference image. If there is a plurality of i^{th}-layer reference images, an i^{th} layer matching result in which each sampling point corresponds to one inverse depth value can be obtained by fusing the obtained plurality of values of punishment (for example, averaging the plurality of values of punishment). For the plurality of inverse depth values of each sampling point, one penalty value corresponding to each inverse depth value can be obtained, i.e., obtaining the i^{th}-layer matching results corresponding to each sampling point.

Specifically, in the embodiments of the present disclosure, as shown in FIG. 6, for the current frame t and m reference frames, where m is a natural number greater than or equal to 1, the image depth estimation apparatus performs, according to the following formula (3), block matching on any sampling point Xₜⁱ=[u, v] in the i^{th}-layer sampling points and a projection point in the corresponding i^{th}-layer projection points, obtained by performing projection with the inverse depth value being d_{z}, to obtain a matching result, in the i^{th}-layer matching results, having inverse depth values of d_{z}:

$$C ( {x}_{t}^{i} , {d}_{z} ) = {\sum }_{r = 1}^{m} f ( {x}_{t}^{i} , {x}_{r}^{i} ) / m , \qquad ( 3 )$$

where x [symbol] represents m projection points in total obtained by respectively projecting, according to the inverse depth value d_{z} in the candidate inverse depth values corresponding to x [symbol] , x [symbol] to i^{th}-layer reference images respectively corresponding to each frame in the m reference frames; f(x [symbol] , x [symbol] ) is a neighborhood pixel value comparison function of x [symbol] and x [symbol] , and the comparison function may be a zero-mean normalized covariance (Zero-mean Normalized Cross Correlation, ZNCC) of neighborhood grayscale values of x [symbol] and x [symbol] , and may also use the two methods of a Sum of absolute differences (SAD) or a Sum of Squared Differences (SSD); C(x [symbol] , d_{z}) is the a matching result of the inverse depth value of d_{z} in the i^{th}-layer matching results corresponding to x [symbol] .

It should be noted that in the embodiments of the present disclosure, the i^{th}-layer matching results corresponding to each sampling point in the i^{th}-layer sampling points include the matching results of different inverse depth values in the inverse depth candidate values corresponding to each sampling point. For example, for any sampling point x [symbol] in the i^{th}-layer sampling points, the corresponding inverse depth candidate values include d1, d2, . . . , and dq, and the obtained i^{th}-layer matching results include the matching result of each inverse depth value. The specific i^{th}-layer matching results are not limited in the embodiments of the present disclosure.

Exemplarily, in the embodiments of the present disclosure, there are two reference frames corresponding to the current frame. Each reference frame corresponds to a group of two layers of reference images. That is, there are two first-layer reference images. The image depth estimation apparatus projects a sampling point x [symbol] in the first-layer current image in the current frame to the two first-layer reference images respectively according to inverse depth candidate values d₁, d₂, and d₃ corresponding to the sampling point to respectively obtain three projection points in each of the two first reference images, i.e., six projection points in total, as the first-layer projection points corresponding to the sampling point. The projection point obtained by performing projection to one first-layer reference image according to d₁ is x [symbol] , and the projection point obtained by performing projection to the other first-layer reference image according to d₁ is x [symbol] . Therefore, x [symbol] , x [symbol] , and x [symbol] can be substituted into formula (3), i.e., m being equal to 2, to obtain the matching results of x [symbol] for the inverse depth value d₁. Similarly, the matching results for the inverse depth values of d₂ and d₃ can also be obtained to constitute the i^{th}-layer matching results corresponding to x [symbol] .

Specifically, in the embodiments of the present disclosure, determining, by the image depth estimation apparatus according to the i^{th}-layer matching results, inverse depth values of each sampling point in the i^{th}-layer sampling points to obtain the i^{th}-layer inverse depth values includes: selecting a target matching result from i^{th}-layer matching results corresponding to a target sampling point, where the target sampling point is any sampling point in the i^{th}-layer sampling points; determining the projection point, in the i^{th}-layer projection points corresponding to the target sampling point, corresponding to the target matching result as a target projection point; determining the inverse depth values, in the inverse depth candidate values, corresponding to the target projection point as the inverse depth values of the target sampling point; and continuing determining the inverse depth values of the sampling points, in the i^{th}-layer sampling points, different from the target sampling point until the inverse depth values of each sampling point in the i^{th}-layer sampling points are determined to obtain the i^{th}-layer inverse depth values.

It should be noted that in the embodiments of the present disclosure, after obtaining the i^{th}-layer matching results corresponding to each sampling point in the i^{th}-layer sampling points, the image depth estimation apparatus can determine the inverse depth values of any sampling point x [symbol] in the i^{th}-layer sampling points according to the following formula (4):

$$d ( {x}_{t}^{i} ) = {argmin}_{arg = {d}_{z}} C ( {x}_{t}^{i} , {d}_{z} ) . \qquad ( 4 )$$

Since the matching result C(x [symbol] ,d_{z}) for the inverse depth value d_{z} in the i^{th}-layer matching results corresponding to x [symbol] is the minimum as compared with the matching results of the other inverse depth values, the corresponding inverse depth value of d_{z} is actually determined as the inverse depth value of x [symbol] .

It can be understood that in the embodiments of the present disclosure, the foregoing process for sampling point matching is actually respectively determining, for a sampling point, the degrees of differences among projection points projected using different inverse depth values. Moreover, determining the inverse depth value using formula (4) is actually selecting a result having the minimum matching result value, which represents the minimum degree of difference between the corresponding projection point and the sampling point. Therefore, the inverse depth value used by the projection point can be determined as the inverse depth value of the sampling point, so as to obtain an accurate inverse depth value of the sampling point.

It should be noted that in the embodiments of the present disclosure, the image depth estimation apparatus can further determine, in other modes, the inverse depth candidate values corresponding to each sampling point in the i^{th}-layer sampling points. For example, some results within a specific range are selected from the matching results corresponding to each sampling point. Then, one matching result is randomly selected from the some results, and the inverse depth value used by the projection point corresponding to the randomly selected matching result is determined as the inverse depth value of the sampling point.

At operation 303, let i equal to i+1 and inverse depth estimation is continued being performed on the (i+1)^{th}-layer current image, in the k layers of current images, having a resolution greater than that of the i^{th}-layer current image until i=k to obtain k^{th}-layer inverse depth values.

In the embodiments of the present disclosure, after the image depth estimation apparatus obtains the i^{th}-layer inverse depth values, let i equal to i+1. Therefore, inverse depth estimation is further continued being performed on the (i+1)^{th}-layer current image, i.e., the i^{th}-layer current image, and the process thereof is the same as the process for obtaining the i^{th}-layer inverse depth values. Details are not described herein again. During a continuous iteration estimation process, when i=k, if the image depth estimation apparatus obtains the k^{th}-layer inverse depth values, i.e., the inverse depth values of each sampling point in the image, in the k layers of current images, having the highest resolution, which is actually the original image of the current frame, letting i equal to i+1 is stopped.

At S304, the k^{th}-layer inverse depth values are determined as inverse depth estimation results.

In the embodiments of the present disclosure, after obtaining the k^{th}-layer inverse depth values, the image depth estimation apparatus determines the k^{th}-layer inverse depth values as the inverse depth estimation results.

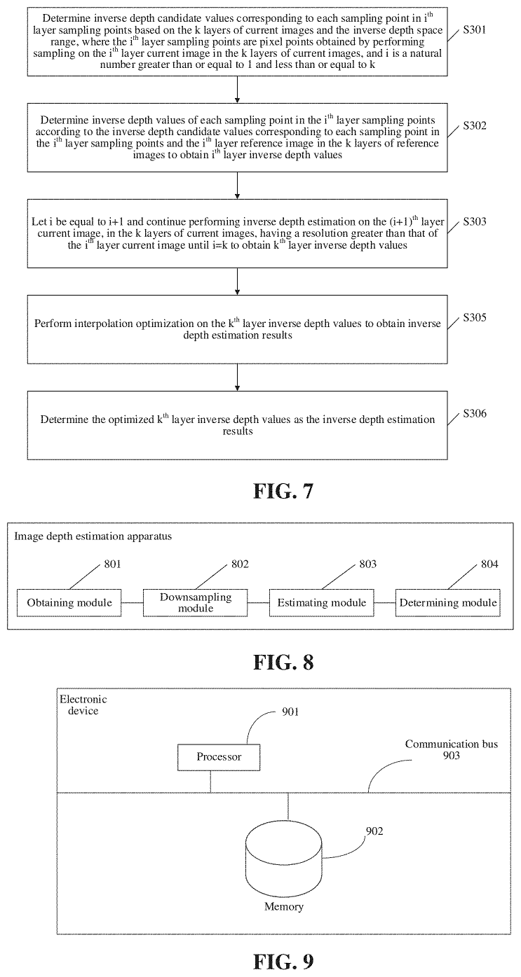

Optionally, the depths estimated in the foregoing process are discrete values. In order to obtain more accurate inverse depths, secondary interpolation may further be performed to adjust the inverse depths of each sampling point. Specifically, as shown in FIGS. 7, S305 and S306 may further be included after operation S303.

At S305, interpolation optimization is performed on the k^{th}-layer inverse depth values to obtain inverse depth estimation results.

In the embodiments of the present disclosure, after obtaining the k^{th}-layer inverse depth values, the k^{th}-layer inverse depth values including inverse depth values corresponding to each sampling point in the k^{th}-layer sampling points, the image depth estimation apparatus can perform interpolation optimization on the k^{th}-layer inverse depth values in order to obtain more accurate k^{th}-layer inverse depth values, i.e., respectively performing adjustment optimization on the inverse depth values of each sampling point in the k^{th}-layer sampling points to obtain optimized k^{th}-layer inverse depth values.

Specifically, in the embodiments of the present disclosure, performing interpolation optimization on the k^{th}-layer inverse depth values by the image depth estimation apparatus to obtain optimized k^{th}-layer inverse depth values includes: for each inverse depth value in the k^{th}-layer inverse depth values, respectively selecting adjacent inverse depth values of the inverse depth value from the candidate inverse depth values of the corresponding sampling points in the k^{th}-layer sampling points, where the k^{th}-layer sampling points are pixel points obtained by performing sampling on the k^{th}-layer current image in the k layers of current images; obtaining matching results corresponding to the adjacent inverse depth values; and performing interpolation optimization on each inverse depth value in the k^{th}-layer inverse depth values based on the adjacent inverse depth values and the matching results corresponding to the adjacent inverse depth values to obtain the optimized k^{th}-layer inverse depth values.

Specifically, in the embodiments of the present disclosure, the k^{th}-layer inverse depth values include the inverse depth values corresponding to each sampling point in the k^{th}-layer sampling points, and the image depth estimation apparatus needs to perform interpolation optimization on the inverse depth values corresponding to each sampling point in the k^{th}-layer sampling points to obtain interpolation optimization results as the inverse depth estimation results of the current frame. For any sampling point x [symbol] in the k^{th}-layer sampling points, if the inverse depth value corresponding to the sampling point is d_{z}, interpolation optimization can be performed according to formula (5):

$${d}_{opt} = {d}_{2} + 0.5 \times ( {d}_{z} - {d}_{z - 1} ) \times ( {C}_{z + 1} - {C}_{z - 1} ) / ( {C}_{z + 1} + {C}_{z - 1} - 2 \times {C}_{z} ) , \qquad ( 5 )$$

where d_{z-1} is a previous inverse depth value adjacent to d_{z} in the inverse depth candidate values corresponding to the sampling point x [symbol] ; C_{z}C_{z+1} is C(Xₐ^{k}, d_{z+1}), C_{z-1} is C(Xₐ^{k}, d_{z-1}), and C_{z} is C(Xₐ^{k}, d_{z}), and they can all be computed by formula (3) when computing the inverse depth values of Xₐ^{k}; d_{z+1} and d_{z-1} are two inverse depth values adjacent to d_{z} in the candidate inverse depth values corresponding to Xₐ^{k}. Details are not described herein again.

It can be understood that in the embodiments of the present disclosure, the image depth estimation apparatus performs interpolation optimization on the k^{th}-layer inverse depth values according to formula (5). Since the k^{th}-layer current image in the k layers of current images is actually the current frame, the inverse depth values of each sampling point in the current frame are actually further optimized after being obtained, to obtain more accurate inverse depth values of each sampling point in the current frame, i.e., to obtain the inverse depth estimation results of the current frame. In the embodiments of the present disclosure, the image depth estimation apparatus can also obtain three or more adjacent inverse depth values and matching results corresponding thereto, and performs interpolation optimization using a polynomial similar to formula (5). In addition, for the inverse depth values of each sampling point in the k^{th}-layer sampling points, the image depth estimation apparatus can also obtain two depth values adjacent to a determined inverse depth value from the inverse depth candidate values corresponding to the sampling point, and takes a mean of the three inverse depth values as the final inverse depth value of the sampling point to implement optimization of the inverse depth value.

At S306, the optimized k^{th}-layer inverse depth values are determined as the inverse depth estimation results.

In the embodiments of the present disclosure, after obtaining the optimized k^{th}-layer inverse depth values, the image depth estimation apparatus determines the optimized k^{th}-layer inverse depth values as the inverse depth estimation results.

Optionally, in the embodiments of the present disclosure, after determining the inverse depth estimation result, i.e., operation S103, the image depth estimation apparatus can further execute the following operation.

At S104, depth estimation results of the current frame are determined according to the inverse depth estimation results.

In the embodiments of the present disclosure, after obtaining the inverse depth estimation results of the current frame, the image depth estimation apparatus can determine depth estimation results of the current frame according to the inverse depth estimation results, where the depth estimation results can be used for implementing three-dimensional scene construction based on the current frame.

It should be noted that in the embodiments of the present disclosure, for a sampling point, the inverse depth values and the depth values thereof are reciprocals of each other. Therefore, after obtaining the inverse depth estimation results of the current frame, i.e., the inverse depth values, subjected to interpolation optimization, of each sampling point in the current frame, the image depth estimation apparatus can obtain the corresponding depth values by obtaining the reciprocals of the inverse depth values, so as to obtain the depth estimation results of the current frame. For example, if the inverse depth value, subjected to interpolation optimization, of a certain sampling point in the current frame is A, the depth value thereof is 1/A.

It should be noted that in the embodiments of the present disclosure, compared with the prior art that a z axis coordinate value in a camera coordinate system can only be obtained by performing computation such as reverse triangulation solving, the final depth estimation result determined with the foregoing image depth estimation method is a z axis coordinate value in a camera coordinate system of the sampling points in the current frame, and does not require additional coordinate transformation.

It should be noted that in the embodiments of the present disclosure, the foregoing image depth estimation method can be applied to a process for implementing three-dimensional scene construction based on the current frame. For example, when capturing an image of a certain scene using a camera of a mobile device, a user can obtain the depth estimation result of the current frame using the foregoing image depth estimation method to reconstruct a 3D structure of a video scene. When pressing a certain position in the current frame of a video in the mobile device, the user can perform line of sight intersection on the pressed position using the depth estimation result of the current frame determined with the foregoing image depth estimation method to find out an anchoring point to place a virtual object, so as to implement an augmented reality effect in which the virtual object and a real scene are fused in geometric consistency fashion. In a monocular video, the foregoing image depth estimation method can be used to recover a three-dimensional scene structure and compute a blocking relationship between the real scene and the virtual object to implement an augmented reality effect in which the virtual object and the real scene are fused in blocking consistency fashion. In a monocular video, the foregoing image depth estimation method can be used to recover a three-dimensional scene structure to obtain a shadow effect having a sense of realism, so as to implement an augmented reality effect in which the virtual object and the real scene are fused in lighting consistency fashion. In a monocular video, the foregoing image depth estimation method can be used to recover a three-dimensional scene structure to implement a physical collision with a virtual animation character, so as to implement an animation effect having a sense of realism in which the virtual animation character and the real scene are fused in physical consistency fashion.

In addition, in the embodiments of the present disclosure, the foregoing operation S104 may not be executed, and the inverse depth estimation results can be used for other image processing rather than three-dimensional scene construction. For example, depth information change values of sampling points of an image are directly output to other devices to perform data processing such as target recognition or three-dimensional point distance computation.

The embodiments of the present disclosure provide an image depth estimation method, including: obtaining a reference frame corresponding to a current frame and an inverse depth space range of the current frame; performing pyramid downsampling processing on the current frame and the reference frame respectively to obtain k layers of current images corresponding to the current frame and k layers of reference images corresponding to the reference frame, where k is a natural number greater than or equal to 2; and performing inverse depth estimation iteration processing on the k layers of current images based on the k layers of reference images and the inverse depth space range to obtain inverse depth estimation results of the current frame. That is to say, the technical solution provided by the present disclosure performs inverse depth estimation iteration processing on a plurality of layers of current images and a plurality of layers of reference images to reduce the inverse depth search space layer by layer to determine the depth estimation results of the current frame. Moreover, the final depth estimation result is a z axis coordinate value of a pixel point of the current frame in a camera coordinate system, and does not require additional coordinate transformation. Therefore, a depth estimation result of an image can be obtained in real time and the depth estimation result has high accuracy.

The embodiments of the present discourse further provide an image depth estimation apparatus. FIG. 8 is a schematic structural diagram of an image depth estimation apparatus provided by embodiments of the present disclosure. As shown in FIG. 8, the image depth estimation apparatus includes:

an obtaining section 801, configured to obtain a reference frame corresponding to a current frame and an inverse depth space range of the current frame;

a downsampling section 802, configured to perform pyramid downsampling processing on the current frame and the reference frame respectively to obtain k layers of current images corresponding to the current frame and k layers of reference images corresponding to the reference frame, where k is a natural number greater than or equal to 2; and

an estimating section 803, configured to perform inverse depth estimation iteration processing on the k layers of current images based on the k layers of reference images and the inverse depth space range to obtain inverse depth estimation results of the current frame.

Optionally, the image depth estimation apparatus of the embodiments of the present disclosure may further include: a determining section 804, configured to determine depth estimation results of the current frame according to the inverse depth estimation results. The depth estimation result can be used for implementing three-dimensional scene construction based on the current frame.

Optionally, the obtaining section 801 is specifically configured to: obtain at least two frames to be screened; and select at least one frame from the at least two frames to be screened and take the at least one frame as the reference frame, where the at least one frame and the current frame meet a preset angle constraint condition.

Optionally, the preset angle constraint condition includes that:

an included angle formed by a connection line between a pose center corresponding to the current frame and a target point and a connection line between a pose center corresponding to the reference frame and the target point falls within a first preset angle range, where the target point is a midpoint of a connection line between an average depth point corresponding to the current frame and an average depth point corresponding to the reference frame;

an included angle between an optical axis corresponding to the current frame and an optical axis corresponding to the reference frame falls within a second preset angle range; and

an included angle between a vertical axis corresponding to the current frame and a vertical axis corresponding to the reference frame falls within a third preset angle range.

Optionally, the estimating section 803 is specifically configured to: determine inverse depth candidate values corresponding to each sampling point in i^{th}-layer sampling points based on the k layers of current images and the inverse depth space range, where the i^{th}-layer sampling points are pixel points obtained by performing sampling on the i^{th}-layer current image in the k layers of current images, and i is a natural number greater than or equal to 1 and less than or equal to k; determine inverse depth values of each sampling point in the i^{th}-layer sampling points according to the inverse depth candidate values corresponding to each sampling point in the i^{th}-layer sampling points and the i^{th}-layer reference image in the k layers of reference images to obtain i^{th}-layer inverse depth values; let i to be equal to i+1 and continue performing inverse depth estimation on the (i+1)^{th}-layer current image, in the k layers of current images, having a resolution greater than that of the i^{th}-layer current image until i=k to obtain k^{th}-layer inverse depth values; and determine the k^{th}-layer inverse depth values as the inverse depth estimation results.

Optionally, the estimating section 803 is specifically configured to: perform interval division on the inverse depth space range and select an inverse depth value from each divided interval to obtain a plurality of initial inverse depth values; determine the plurality of initial inverse depth values as inverse depth candidate values corresponding to each sampling point in the first-layer sampling points; if i is not equal to 1, obtain (i−1)^{th}-layer sampling points from the k layers of current images and (i−1)^{th}-layer inverse depth values; and determine, based on the (i−1)^{th} layer inverse depth values, the (i−1)^{th}-layer sampling points, and the plurality of initial inverse depth values, the inverse depth candidate values corresponding to each sampling point in the i^{th}-layer sampling points.

Optionally, the estimating section 803 is specifically configured to: determine a second sampling point closest to a first sampling point and at least two third sampling points adjacent to the second sampling point from the (i−1)^{th}-layer sampling points, where the first sampling point is any sampling point in the i^{th}-layer sampling points; obtain the inverse depth value of each sampling point in the at least two third sampling points and the inverse depth value of the second sampling point according to the (i−1)^{th}-layer inverse depth values to obtain at least three inverse depth values; determine the maximum inverse depth value and the minimum inverse depth value from the at least three inverse depth values; select, from the plurality of initial inverse depth values, inverse depth values falling within a range between the maximum inverse depth value and the minimum inverse depth value, and determine the selected inverse depth values as the inverse depth candidate values corresponding to the first sampling point; and continue determining inverse depth candidate values corresponding to the sampling points, other than the first sampling point, in the i^{th}-layer sampling points until the inverse depth candidate values corresponding to each sampling point in the i^{th}-layer sampling points are determined.

Optionally, the estimating section 803 is specifically configured to: for each sampling point in the i^{th}-layer sampling points, project each sampling point in the i^{th}-layer sampling points to the i^{th}-layer reference image respectively according to each inverse depth value in the corresponding inverse depth candidate values to obtain i^{th}-layer projection points corresponding to each sampling point in the i^{th}-layer sampling points; perform block matching according to the i^{th}-layer sampling points and the i^{th}-layer projection points to obtain i^{th}-layer matching results corresponding to each sampling point in the i^{th}-layer sampling points; and determine, according to the i^{th}-layer matching results, the inverse depth values of each sampling point in the i^{th}-layer sampling points to obtain the i^{th}-layer inverse depth values.

Optionally, the estimating section 803 is specifically configured to: by using a preset window, select, from the i^{th}-layer current image, a first image block with a sampling point to be matched as a center, and select, from the i^{th}-layer reference image, a plurality of second image blocks respectively with each projection point in the i^{th}-layer projection points corresponding to the sampling point to be matched as a center, where the sampling to be matched is any sampling point in the i^{th}-layer sampling points; respectively compare the first image block with each image block in the plurality of second image blocks to obtain a plurality of matching results, and determine the plurality of matching results as i^{th}-layer matching results corresponding to the sampling point to be matched; and continue determining the i^{th}-layer matching results corresponding to the sampling points, in the i^{th}-layer sampling points, different from the sampling point to be matched, until the i^{th}-layer matching results corresponding to each sampling point in the i^{th}-layer sampling points are obtained.

Optionally, the estimating section 803 is specifically configured to: select a target matching result from i^{th}-layer matching results corresponding to a target sampling point, where the target sampling point is any sampling point in the i^{th}-layer sampling points; determine the projection point, in the i^{th}-layer projection points corresponding to the target sampling point, corresponding to the target matching result as a target projection point; determine inverse depth values, in the inverse depth candidate values, corresponding to the target projection point as inverse depth values of the target sampling point; and continue determining the inverse depth values of the sampling points, in the i^{th}-layer sampling points, different from the target sampling point until the inverse depth values of each sampling point in the i^{th}-layer sampling points are determined to obtain the i^{th}-layer inverse depth values

Optionally, the estimating section 803 is further configured to: perform interpolation optimization on the k^{th}-layer inverse depth values to obtain optimized k^{th}-layer inverse depth values; and determine the optimized k^{th}-layer inverse depth values as the inverse depth estimation results.

Optionally, the estimating section 803 is specifically configured to: for each inverse depth value in the k^{th}-layer inverse depth values, respectively select adjacent inverse depth values from the candidate inverse depth values of a corresponding sampling point in the k^{th}-layer sampling points, where the k^{th}-layer sampling points are pixel points obtained by performing sampling on the k^{th}-layer current image in the k layers of current images; obtain matching results corresponding to the adjacent inverse depth values; and perform interpolation optimization on each inverse depth value in the k^{th}-layer inverse depth values based on the adjacent inverse depth values and the matching results corresponding to the adjacent inverse depth values to obtain the optimized k^{th}-layer inverse depth values.

The embodiments of the present disclosure provide an image depth estimation apparatus, including: obtaining a reference frame corresponding to a current frame and an inverse depth space range of the current frame; performing pyramid downsampling processing on the current frame and the reference frame respectively to obtain k layers of current images corresponding to the current frame and k layers of reference images corresponding to the reference frame, where k is a natural number greater than or equal to 2; and performing inverse depth estimation iteration processing on the k layers of current images based on the k layers of reference images and the inverse depth space range to obtain inverse depth estimation results of the current frame. That is to say, the image depth estimation apparatus provided by the present disclosure performs inverse depth estimation iteration processing on a plurality of layers of current images in combination with a plurality of layers of reference images to reduce the inverse depth search space layer by layer to determine the depth estimation result of the current frame. Moreover, the final depth estimation result is a z axis coordinate value of a pixel point of the current frame in a camera coordinate system, and does not require additional coordinate transformation. Therefore, a depth estimation result of an image can be obtained in real time and the depth estimation result has high accuracy.

The embodiments of the present disclosure further provide an electronic device. FIG. 9 is a schematic structural diagram of an electronic device provided by embodiments of the present disclosure. As shown in FIG. 9, the electronic device includes: a processor 901, a memory 902, and a communication bus 903, where

the communication bus 903 is configured to implement connection communication between the processor 901 and the memory 902; and

the processor 901 is configured to execute an image depth estimation program stored in the memory 902 to implement the foregoing image depth estimation method.

It should be noted that in the embodiments of the present disclosure, the electronic device is a mobile phone or a tablet computer, and certainly may also be other types of devices, which is not limited in the embodiments of the present disclosure.

The embodiments of the present disclosure further provide a computer-readable storage medium, where the computer-readable storage medium stores one or more programs, and the one or more programs may be executed by one or more processors so as to implement the foregoing image depth estimation method. The computer-readable storage medium may be a volatile memory such as a Random-Access Memory (RAM), or a non-volatile memory such as a Read-Only Memory (ROM), a flash memory, a Hard Disk Drive (HDD) or a Solid-State Drive (SSD), and may also be a device including one or any combination of the foregoing memories, such as a mobile phone, a computer, a tablet device, and a personal digital assistant.

The embodiments of the present disclosure further provide a computer program including computer-readable codes, where when the computer-readable codes are executed by a processor, the operations corresponding to the foregoing image depth estimation method are implemented.

A person skilled in the art should understand that the embodiments of the present disclosure may provide a method, a system or a computer program product. Therefore, the present disclosure may use the forms of hardware embodiments, software embodiments, or the embodiments of combining software and hardware aspects. Moreover, the present disclosure may use the form of the computer program product implemented over one or more computer usable storage media (including but not limited to a disk memory and an optical memory, etc.) that include a computer usable program code.

The present disclosure is described with reference to flowcharts and/or block diagrams of methods, devices (systems), and computer program products of the embodiments of the present disclosure. It should be understood that a computer program instruction is configured to implement each flow and/or block in the flowcharts and/or block diagrams, and the combination of flows/blocks in the flowcharts and/or block diagrams. These computer program instructions may be provided to a processor of a general purpose computer, a special purpose computer, an embedded processor or other programmable signal processing devices to produce a machine, so that the instructions are executed by the processor of a computer or other programmable signal processing devices to produce a device for implementing functions specified in one or more flows of the flowcharts or in one or more blocks of the block diagrams.

The computer program instructions can also be stored in a computer-readable memory that can direct a computer or other programmable signal processing device to operate in a particular manner, such that the instructions stored in the computer-readable memory produce a product including the instruction device. The instruction apparatus implements the functions specified in one or more flows of the flowcharts and/or in one or more blocks of the block diagrams.

These computer program instructions may also be loaded onto a computer or other programmable signal processing devices such that a series of operational operations are executed on the computer or other programmable devices to produce computer implemented processing, so that instructions executed on the computer or other programmable devices provide operations for implementing the functions specified in one or more flows of the flowcharts and/or in one or more blocks of the block diagrams.

The foregoing descriptions are merely some of the embodiments of the present disclosure, but are not intended to limit the scope of protection of the present disclosure. Different embodiments in the present application may be mutually combined without violating logic. The different embodiments emphasize different aspects, and for a part not described in detail, reference may be made to descriptions of other embodiments.

### INDUSTRIAL APPLICABILITY

In the technical solutions of the embodiments of the present disclosure, a reference frame corresponding to a current frame and an inverse depth space range of the current frame are obtained; pyramid downsampling processing is performed on the current frame and the reference frame respectively to obtain k layers of current images corresponding to the current frame and k layers of reference images corresponding to the reference frame, where k is a natural number greater than or equal to 2; and inverse depth estimation iteration processing is performed on the k layers of current images based on the k layers of reference images and the inverse depth space range to obtain inverse depth estimation results of the current frame. That is to say, the technical solutions provided by the present disclosure perform inverse depth estimation iteration processing on a plurality of layers of current images in combination with a plurality of layers of reference images to reduce the inverse depth search space layer by layer to determine the inverse depth estimation results of the current frame. The inverse depth estimation results are reciprocals of z axis coordinate values of pixel points of the current frame in a camera coordinate system, and do not require additional coordinate transformation. Moreover, reducing the inverse depth search space layer by layer facilitates reducing the computation load of inverse depth estimation and improving an estimation speed. Therefore, a depth estimation result of an image can be obtained in real time and the depth estimation result has high accuracy.

1. An image depth estimation method, comprising:
obtaining a reference frame corresponding to a current frame and an inverse depth space range of the current frame;
performing pyramid downsampling processing on the current frame and the reference frame respectively to obtain k layers of current images corresponding to the current frame and k layers of reference images corresponding to the reference frame, wherein k is a natural number greater than or equal to 2; and
performing inverse depth estimation iteration processing on the k layers of current images based on the k layers of reference images and the inverse depth space range to obtain inverse depth estimation results of the current frame.

2. The image depth estimation method according to claim 1, wherein obtaining the reference frame corresponding to the current frame comprises:
obtaining at least two frames to be screened; and
selecting at least one frame from the at least two frames to be screened and taking the at least one frame as the reference frame, wherein the at least one frame and the current frame meet a preset angle constraint condition.

3. The image depth estimation method according to claim 2, wherein the preset angle constraint condition comprises that:
an included angle, formed by a connection line between a pose center corresponding to the current frame and a target point and a connection line between a pose center corresponding to the reference frame and the target point, falls within a first preset angle range, wherein the target point is a midpoint of a connection line between an average depth point corresponding to the current frame and an average depth point corresponding to the reference frame;
an included angle between an optical axis corresponding to the current frame and an optical axis corresponding to the reference frame falls within a second preset angle range; and
an included angle between a vertical axis corresponding to the current frame and a vertical axis corresponding to the reference frame falls within a third preset angle range.

4. The image depth estimation method according to claim 1, wherein performing inverse depth estimation iteration processing on the k layers of current images based on the k layers of reference images and the inverse depth space range to obtain inverse depth estimation results of the current frame comprises:
determining inverse depth candidate values corresponding to each sampling point in i^{th}-layer sampling points based on the k layers of current images and the inverse depth space range, wherein the i^{th}-layer sampling points are pixel points obtained by performing sampling on an i^{th}-layer current image in the k layers of current images, and i is a natural number greater than or equal to 1 and less than or equal to k;
determining inverse depth values of each sampling point in the i^{th}-layer sampling points according to the inverse depth candidate values corresponding to each sampling point in the i^{th}-layer sampling points and the i^{th}-layer reference image in the k layers of reference images to obtain i^{th}-layer inverse depth values;
letting i be equal to i+1 and continuing performing inverse depth estimation on the (i+1)^{th}-layer current image, in the k layers of current images, having a resolution greater than that of the i^{th}-layer current image until i=k to obtain k^{th}-layer inverse depth values; and
determining the k^{th}-layer inverse depth values as the inverse depth estimation results.

5. The image depth estimation method according to claim 4, wherein determining inverse depth candidate values corresponding to each sampling point in i^{th}-layer sampling points based on the k layers of current images and the inverse depth space range comprises:
performing interval division on the inverse depth space range and selecting an inverse depth value from each divided interval to obtain a plurality of initial inverse depth values;
determining the plurality of initial inverse depth values as inverse depth candidate values corresponding to each sampling point in the first-layer sampling points;
if i is not equal to 1, obtaining (i−1)^{th}-layer sampling points from the k layers of current images and (i−1)^{th}-layer inverse depth values; and
determining, based on the (i−1)^{th}-layer inverse depth values, the (i−1)^{th}-layer sampling points, and the plurality of initial inverse depth values, the inverse depth candidate values corresponding to each sampling point in the i^{th}-layer sampling points.

6. The image depth estimation method according to claim 5, wherein determining, based on the (i−1)^{th} layer inverse depth values, the (i−1)^{th}-layer sampling points, and the plurality of initial inverse depth values, the inverse depth candidate values corresponding to each sampling point in the i^{th}-layer sampling points comprises:
determining, from the (i−1)^{th}-layer sampling points, a second sampling point closest to a first sampling point and at least two third sampling points adjacent to the second sampling point, wherein the first sampling point is any sampling point in the i^{th}-layer sampling points;
obtaining an inverse depth value of each sampling point in the at least two third sampling points and an inverse depth value of the second sampling point according to the (i−1)^{th}-layer inverse depth values to obtain at least three inverse depth values;
determining a maximum inverse depth value and a minimum inverse depth value from the at least three inverse depth values;
selecting, from the plurality of initial inverse depth values, inverse depth values falling within a range between the maximum inverse depth value and the minimum inverse depth value, and determining the selected inverse depth values as the inverse depth candidate values corresponding to the first sampling point; and
continuing determining inverse depth candidate values corresponding to the sampling points, other than the first sampling point, in the i^{th}-layer sampling points until the inverse depth candidate values corresponding to each sampling point in the i^{th}-layer sampling points are determined.

7. The image depth estimation method according to claim 4, wherein determining inverse depth values of each sampling point in the i^{th}-layer sampling points according to the inverse depth candidate values corresponding to each sampling point in the i^{th}-layer sampling points and the i^{th}-layer reference image in the k layers of reference images to obtain i^{th}-layer inverse depth values comprises:
for each sampling point in the i^{th}-layer sampling points, projecting each sampling point in the i^{th}-layer sampling points to the i^{th}-layer reference image according to each inverse depth value in the corresponding inverse depth candidate values respectively to obtain i^{th}-layer projection points corresponding to each sampling point in the i^{th}-layer sampling points;
performing block matching according to the i^{th}-layer sampling points and the i^{th}-layer projection points to obtain i^{th}-layer matching results corresponding to each sampling point in the i^{th}-layer sampling points; and
determining, according to the i^{th}-layer matching results, the inverse depth values of each sampling point in the i^{th}-layer sampling points to obtain the i^{th}-layer inverse depth values.

8. The image depth estimation method according to claim 7, wherein performing block matching according to the i^{th}-layer sampling points and the i^{th}-layer projection points to obtain i^{th}-layer matching results corresponding to each sampling point in the i^{th}-layer sampling points comprises:
by using a preset window, selecting, from the i^{th}-layer current image, a first image block with a sampling point to be matched as a center, and selecting, from the i^{th}-layer reference image, a plurality of second image blocks respectively with each projection point in the i^{th}-layer projection points corresponding to the sampling point to be matched as a center, wherein the sampling to be matched is any sampling point in the i^{th}-layer sampling points;
respectively comparing the first image block with each image block in the plurality of second image blocks to obtain a plurality of matching results, and determining the plurality of matching results as i^{th}-layer matching results corresponding to the sampling point to be matched; and
continuing determining the i^{th}-layer matching results corresponding to the sampling points, in the i^{th}-layer sampling points, different from the sampling point to be matched, until the i^{th}-layer matching results corresponding to each sampling point in the i^{th}-layer sampling points are obtained.

9. The image depth estimation method according to claim 7, wherein determining, according to the i^{th}-layer matching results, the inverse depth values of each sampling point in the i^{th}-layer sampling points to obtain the i^{th}-layer inverse depth values comprises:
selecting a target matching result from i^{th}-layer matching results corresponding to a target sampling point, wherein the target sampling point is any sampling point in the i^{th}-layer sampling points;
determining the projection point, in i^{th}-layer projection points corresponding to the target sampling point, corresponding to the target matching result as a target projection point;
determining inverse depth values, in the inverse depth candidate values, corresponding to the target projection point as inverse depth values of the target sampling point; and
continuing determining the inverse depth values of the sampling points, in the i^{th}-layer sampling points, different from the target sampling point until the inverse depth values of each sampling point in the i^{th}-layer sampling points are determined to obtain the i^{th}-layer inverse depth values.

10. The image depth estimation method according to claim 4, after obtaining the k^{th}-layer inverse depth values, further comprising:
performing interpolation optimization on the k^{th}-layer inverse depth values to obtain optimized k^{th}-layer inverse depth values; and
determining the optimized k^{th}-layer inverse depth values as the inverse depth estimation results.

11. The image depth estimation method according to claim 10, wherein performing interpolation optimization on the k^{th}-layer inverse depth values to obtain optimized k^{th}-layer inverse depth values comprises:
for each inverse depth value in the k^{th}-layer inverse depth values, respectively selecting adjacent inverse depth values of the inverse depth value from candidate inverse depth values of a corresponding sampling point in the k^{th}-layer sampling points, wherein the k^{th}-layer sampling points are pixel points obtained by performing sampling on the k^{th}-layer current image in the k layers of current images;
obtaining matching results corresponding to the adjacent inverse depth values; and
performing interpolation optimization on each inverse depth value in the k^{th}-layer inverse depth values based on the adjacent inverse depth values and the matching results corresponding to the adjacent inverse depth values to obtain the optimized k^{th}-layer inverse depth values.

12. An electronic device, comprising: a processor, a memory, and a communication bus, wherein
the communication bus is configured to implement connection communication between the processor and the memory; and
the processor is configured to execute an image depth estimation program stored in the memory, when the image depth estimation program are executed by the processor, the processor is configured to:
obtain a reference frame corresponding to a current frame and an inverse depth space range of the current frame;
perform pyramid downsampling processing on the current frame and the reference frame respectively to obtain k layers of current images corresponding to the current frame and k layers of reference images corresponding to the reference frame, wherein k is a natural number greater than or equal to 2; and
perform inverse depth estimation iteration processing on the k layers of current images based on the k layers of reference images and the inverse depth space range to obtain inverse depth estimation results of the current frame.

13. The electronic device according to claim 12, wherein
the processor is specifically configured to: obtain at least two frames to be screened; and
select at least one frame from the at least two frames to be screened and take the at least one frame as the reference frame, wherein the at least one frame and the current frame meet a preset angle constraint condition.

14. The electronic device according to claim 13, wherein the preset angle constraint condition comprises that:
an included angle, formed by a connection line between a pose center corresponding to the current frame and a target point and a connection line between a pose center corresponding to the reference frame and the target point, falls within a first preset angle range, wherein the target point is a midpoint of a connection line between an average depth point corresponding to the current frame and an average depth point corresponding to the reference frame;
an included angle between an optical axis corresponding to the current frame and an optical axis corresponding to the reference frame falls within a second preset angle range; and
an included angle between vertical axis corresponding to the current frame and a vertical axis corresponding to the reference frame falls within a third preset angle range.

15. The electronic device according to claim 12, wherein
the processor is specifically configured to: determine inverse depth candidate values of each sampling point in i^{th}-layer sampling points based on the k layers of current images and the inverse depth space range, wherein the i^{th}-layer sampling points are pixel points obtained by performing sampling on an i^{th}-layer current image in the k layers of current images, and i is a natural number greater than or equal to 1 and less than or equal to k; determine inverse depth values of each sampling point in the i^{th}-layer sampling points according to the inverse depth candidate values corresponding to each sampling point in the i^{th}-layer sampling points and the i^{th}-layer reference image in the k layers of reference images to obtain i^{th}-layer inverse depth values; let i to be equal to i+1 and continue performing inverse depth estimation on the (i+1)th-layer current image, in the k layers of current images, having a resolution greater than that of the i^{th}-layer current image until i=k to obtain k^{th}-layer inverse depth values; and determine the k^{th}-layer inverse depth values as the inverse depth estimation results.

16. The electronic device according to claim 15, wherein
the processor is specifically configured to: perform interval division on the inverse depth space range and select an inverse depth value from each divided interval to obtain a plurality of initial inverse depth values; determine the plurality of initial inverse depth values as inverse depth candidate values corresponding to each sampling point in the first-layer sampling points; if i is not equal to 1, obtain (i−1)^{th}-layer sampling points from the k layers of current images and (i−1)^{th}-layer inverse depth values; and determine, based on the (i−1)^{th} layer inverse depth values, the (i−1)^{th}-layer sampling points, and the plurality of initial inverse depth values, the inverse depth candidate values corresponding to each sampling point in the i^{th}-layer sampling points.

17. The electronic device according to claim 16, wherein
the processor is specifically configured to: determine a second sampling point closest to a first sampling point and at least two third sampling points adjacent to the second sampling point from the (i−1)^{th}-layer sampling points, wherein the first sampling point is any sampling point in the i^{th}-layer sampling points; obtain an inverse depth value of each sampling point in the at least two third sampling points and an inverse depth value of the second sampling point according to the (i−1)^{th}-layer inverse depth values to obtain at least three inverse depth values; determine a maximum inverse depth value and a minimum inverse depth value from the at least three inverse depth values; select, from the plurality of initial inverse depth values, inverse depth values falling within a range between the maximum inverse depth value and the minimum inverse depth value, and determine the selected inverse depth values as inverse depth candidate values corresponding to the first sampling point; and continue determining inverse depth candidate values corresponding to the sampling points, other than the first sampling point, in the i^{th}-layer sampling points until the inverse depth candidate values corresponding to each sampling point in the i^{th}-layer sampling points are determined.

18. The electronic device according to claim 15, wherein
the processor is specifically configured to: for each sampling point in the i^{th}-layer sampling points, project each sampling point in the i^{th}-layer sampling points to the i^{th}-layer reference image according to each inverse depth value in the corresponding inverse depth candidate values respectively to obtain i^{th}-layer projection points corresponding to each sampling point in the i^{th}-layer sampling points; perform block matching according to the i^{th}-layer sampling points and the i^{th}-layer projection points to obtain i^{th}-layer matching results corresponding to each sampling point in the i^{th}-layer sampling points; and determine, according to the i^{th}-layer matching results, the inverse depth values of each sampling point in the i^{th}-layer sampling points to obtain the i^{th}-layer inverse depth values.

19. The electronic device according to claim 18, wherein
the processor is specifically configured to: by using a preset window, select, from the i^{th}-layer current image, a first image block with a sampling point to be matched as a center, and select, from the i^{th}-layer reference image, a plurality of second image blocks respectively with each projection point in the i^{th}-layer projection points corresponding to the sampling point to be matched as a center, wherein the sampling to be matched is any sampling point in the i^{th}-layer sampling points; respectively compare the first image block with each image block in the plurality of second image blocks to obtain a plurality of matching results, and determine the plurality of matching results as i^{th}-layer matching results corresponding to the sampling point to be matched; and continue determining the i^{th}-layer matching results corresponding to the sampling points, in the i^{th}-layer sampling points, different from the sampling point to be matched, until the i^{th}-layer matching results corresponding to each sampling point in the it-layer sampling points are obtained.

20. A computer-readable storage medium, having one or more programs stored thereon, wherein the one or more programs are executable by one or more processors to perform:
obtaining a reference frame corresponding to a current frame and an inverse depth space range of the current frame;
performing pyramid downsampling processing on the current frame and the reference frame respectively to obtain k layers of current images corresponding to the current frame and k layers of reference images corresponding to the reference frame, wherein k is a natural number greater than or equal to 2; and
performing inverse depth estimation iteration processing on the k layers of current images based on the k layers of reference images and the inverse depth space range to obtain inverse depth estimation results of the current frame.
